(19) United States
(12) Patent Application Publication
(10) Pub. No.: US 2015/0119151 A1
(43) Pub. Date: Apr. 30, 2015

(54) TWO-PART OR INTEGRAL FLEXIBLE COUPLING FOR HIGH TORQUE

(71) Applicant: Rui Guedelha Coutinho, São Paulo, SP (BR)

(72) Inventor: Rui Guedelha Coutinho, Sao Paulo (BR)

(21) Appl. No.: 14/377,436

(22) PCT Filed: Feb. 15, 2013
(86) PCT No.: PCT/BR2013/000046

§ 371 Date: Dec. 4, 2014

(30) Foreign Application Priority Data
Feb. 17, 2012 (BR) 10 2012 003732 7

(51) Int. Cl. F16D 3/52; F16D 3/68

(52) U.S. Cl. CPC F16D 3/52; F16D 3/68
USPC 464/80

(57) ABSTRACT

Two-part or integral flexible coupling for high transmission torque composed of a flexible element constructed with belts that are moved by traction and equalized at bearing points covered with elastomeric sheathing that provides the assembly with flexibility and small diameters.

The present invention deals with equipment for transmission of rotary motion with the advantages of absorption of shock, vibration, and misalignment, for use in equipment using gear couplings, with an unprecedented design providing for equivalent torque transmission and maintaining reduced dimensions comparable to gearing made of steel.

The high torque required in transmissions of low rotational movement, such as conveyor belts, mills, grinders and equipment with elevated inertia, requires couplings with elevated transmission capability and dimensions proportional to those used normally in these applications; the truly elastic two-part or integral couplings which are able to transmit the torque required in these applications are not used, due to the size which they would have and due to the modifications that would be needed for the installation of the already existing equipment.

The designs of elastic rubber couplings with internal reinforcement of canvas or fabric of various materials or of synthetic elastomers with internal reinforcement, integral or two-part types, are able to transmit the torque between the driving axle and the driven axle by the friction between the elastomer and the metal flange where the elastomer with its reinforcements is fixed, thus requiring for a larger torque an ever increasing diameter of the elastomer part and its flange, or else there will be an inevitable separation between the elastomer and metal parts, causing an interruption in the transmission and a stoppage of the equipment. In these couplings of two-part design, the diameters required for high torque are two or more times larger than the diameter of metal gear couplings of the same torque capacity, creating various problems such as excessive weight, elevated cost, and difficult installation.

The above-mentioned problems are eliminated by the present invention, due to the way in which the transmission of the motion by the metal part of the driving axle to the metal part of the driven axle takes place, which is not by friction but by traction of various belts of polyester or other materials which can be used, depending on the need, providing a very high torque transmission power with small diameters. The other characteristics of the invention are that the forces resulting from the traction exerted on the belts, upon undergoing sudden changes in acceleration or braking of one of the axles, tend to break or twist irregularly, causing lurching; the solution to this problem, which is the primary characteristic of the invention, is a central column of metal material between the attachments of the belts on the driving flange and the driven flange with a larger diameter where the belts are attached on one side and the other, so that the forces which move by traction the moving side of the element are equalized, providing a resultant combined force of each belt always in the same direction, whether in one direction or abruptly reversing when braked and moved by traction in the opposite direction. The element constructed with these belts equalized by the central column will become flexible because it is coated with elastomer material, always positioning the belts in arc shape so that they can bend and absorb the movements of the respective axles where the coupling is transmitting rotation movement, which is the resulting force directed by the assembly of belts, attached at their flanges, which are secured to the hubs by bolts, which in turn are secured to the axles under traction, normally by metal splines.

We shall now present drawings for a better understanding of the invention:

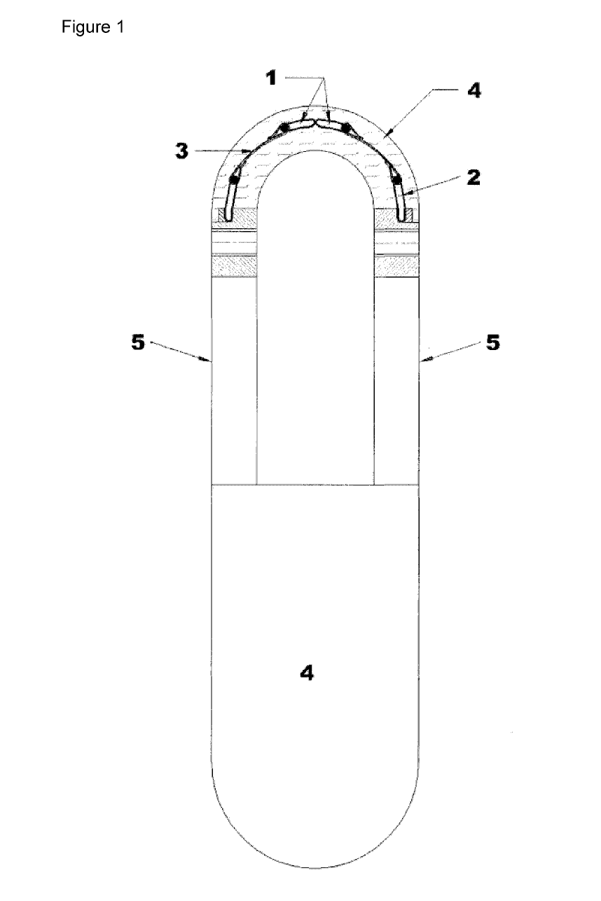

FIG. 01 is a cross sectional view of the flexible element.

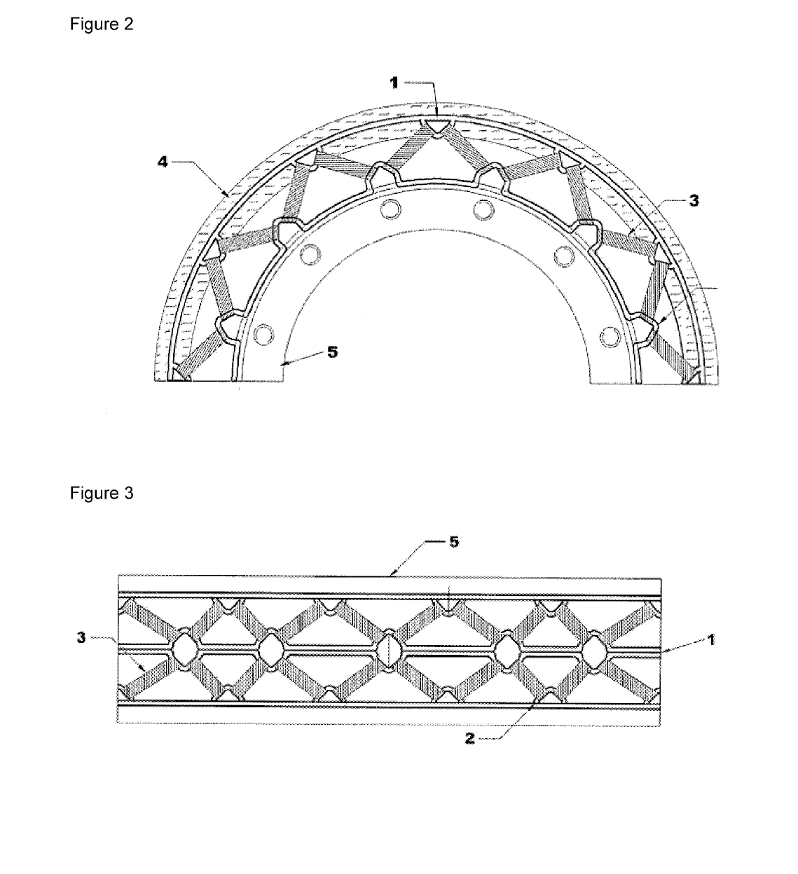

FIG. 02 is a longitudinal section of the flexible element.

FIG. 03 is a top view of the flexible element without the elastomer sheath.

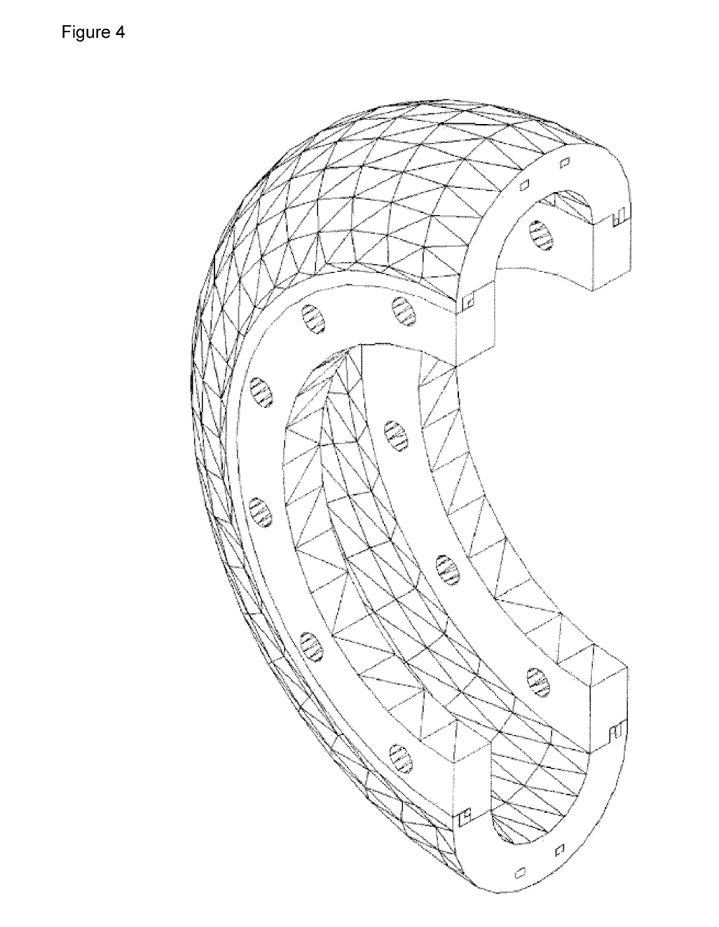

FIG. 04 is a 3D view of half of the elastic element.

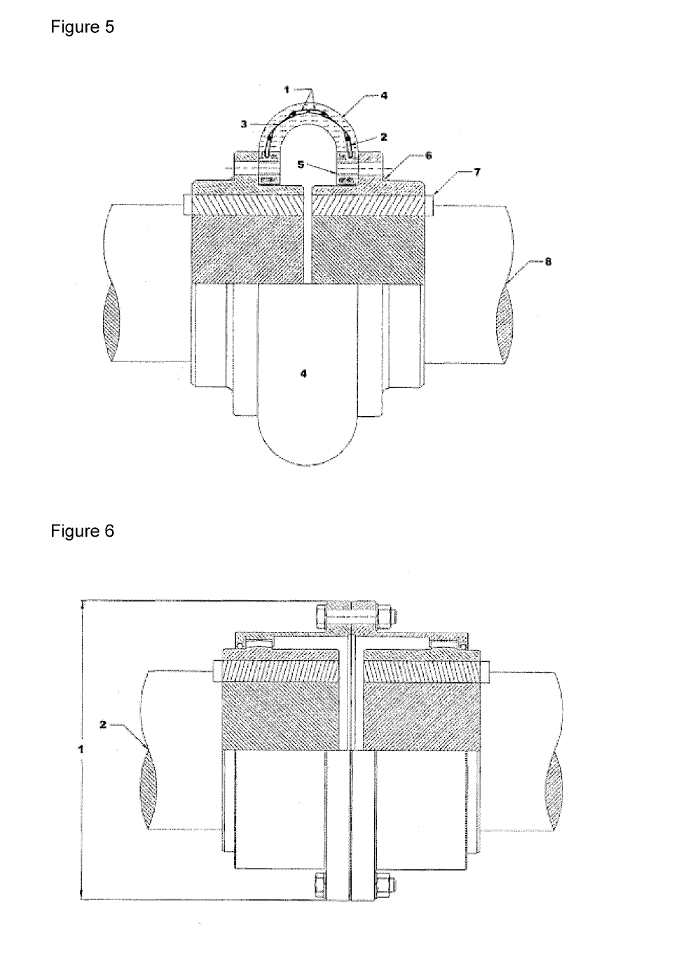

FIG. 05 is a view of the complete two-part coupling already mounted on the axles.

FIG. 06 shows a gear coupling of equivalent diameter which transmits 42,000 Nm of torque.

FIG. 01 shows how the belts (3), which are made of polyester with traction strength up to 700 kg with a width of 10 mm, will be stitched after enclosing the metal side hooks (2), which are made of bent steel wire, in this example having a diameter of 3 mm, and welded to the flanges (5), which are made of SAE 1045 steel, the other side of the belts encloses the hooks of the central metal column (1) and they are stitched; the same procedure is done at the other end, forming with the other half (4) the complete element.

FIG. 02 also shows the central metal column (1), which equalizes the traction forces exerted by the belts (3) attached to the side hooks (2), which are welded to the flanges, where the bolts securing the hubs to the two-part elements will be screwed in.

FIG. 03 gives a better idea of how the trellis of belts (3) will be installed, which will go inside the flexible element, and how the traction forces push the side hooks (2) welded to the flange, which consequently turn the central metal column (1) which distributes the traction to the other flange, moving the hub and ultimately the axle being moved.

FIG. 04 shows how one half of the two-part elastic element now with the elastomer sheath, which is vulcanized in a metal mold, thus allowing the belts to beheld in arc position so that, when moved by traction, they undergo a flexure, absorbing shocks and sudden torque changes, and returning to the initial position.

FIG. 05 shows the complete coupling with the driving axle (8) mounted, showing the element (4) and its elastomer sheath, maintaining the belts of polyester (3) attached to the central metal column (1) inside it, interconnecting the two ends of the metal hooks (2) that are welded to the metal flanges (5) and that will be secured by steel bolts to the hubs (6), which in turn will be transmitting the motion to the driven axle (9) via metal splines (7); in this example we have a maximum axle diameter of 190 mm, an external diameter of the hubs of 320 mm and an external diameter of the element of 440 mm, which in this configuration will be able to transmit a torque of up to 50,000 Nm, depending on the strength of the belt being used, which is equivalent to a gear coupling with external diameter (1) of 346 mm with torque transmission ability of 42,000 Nm and maximum axle diameter (2) of 183 mm, as shown by FIG. 06.

1. A flexible two-part coupling for high torque, characterized in that the movement is transmitted by a system of belts of polyester or other material, interconnected by a central metal column which equalizes the traction forces applied by the operation and its metal parts, which connect the flexible element to the axles.

2. An integral flexible coupling in accordance with claim 1, characterized by its torque transmission system being a group of belts of polyester or other material, interconnected by a central metal column which equalizes the traction forces applied by the operation and its metal parts, which connect the flexible element to the axles.

3. The flexible coupling according to claim 1, further characterized in being enclosed in a vulcanized elastomer sheath.

4. A construction method for the two-part or integral flexible element in accordance with claim 1, characterized by the securing of steel wire hooks of the lateral flanges, which are welded and secured by steel ring, where the traction belts are attached, which will go to the central metal column, enclosed in elastomer material, and afterwards mounted in a steel mold and vulcanized.
